(19) United States
(12) Patent Application Publication
(10) Pub. No.: US 2014/0082520 A1
(43) Pub. Date: Mar. 20, 2014

(54) Method and System for Gesture- and Animation-Enhanced Instant Messaging

(71) Applicant: Monir Mamoun, Morristown, NJ (US)

(72) Inventor: Monir Mamoun, Morristown, NJ (US)

(21) Appl. No.: 13/902,781

(22) Filed: May 24, 2013

Related U.S. Application Data
(60) Provisional application No. 61/651,504, filed on May 24, 2012.

(51) Int. Cl. G06F 3/01

(52) U.S. Cl. CPC G06F 3/017
USPC 715/752

(57) ABSTRACT

Instant messaging applications of all forms, ranging from standard short-message-service (SMS) text messaging to basic multimedia messaging incorporating sounds and images, to myriad “chat” applications, have become a staple form of communication for millions or billions of phone, computer and mobile device users. The following invention is composed of a set of claims that comprise a novel method and system for an enhanced, more expressive system of messaging that combines text and multimedia (audio, images and video) with a gesture-driven, animated interface especially suited for the newest generation of touch-sensitive mobile device screens. An additional set of claims extends the gesture-driven interface to include “hands-free” spatial-gesture-recognizing-devices which can read and interpret physical hand and body gestures made in the environment adjacent to the device without actual physical contact, as well as adaptations for less-advanced traditional computers with keyboard and mouse.

### CROSS-REFERENCE TO RELATED APPLICATIONS

This patent claims benefit of priority from provisional patent filing 61/651504, Method and System for Gesture—and Animation—Enhanced Instant Messaging by Monir Mamoun.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not applicable

### BACKGROUND OF THE INVENTION

1. Field of the Invention

The current state of the art for messaging is comprised of myriad combinations of basic techniques involving the exchanging of messages between two or more concurrent users through the following means: text input, typically by physical or virtual (on-screen) keyboard and possibly by voice input transcribed by the device; user-typed inclusion of “emoticons” including text-based symbolizations of emotional expression such as, but not limited to, smiley faces such as the symbols (without quotes) of “:)” or “:-)” or sad faces such as “:(” or “:-(” or winky faces “;)”; graphical icon representations, sometimes animated, which are user-selected from a menu embedded in the application and injected in-line into the text stream, of emoticons or other stylized representations of faces, people, animals or things; short textual expressions which have gained a traditional meaning within the broad community of chat users such as “LOL” for “laughing out loud” or “ROTFL” for “rolling on the floor laughing” or “brb” for “be right back”; user-selected sound events that may be embedded into the message either by menu provided by the application or via user upload, possibly pre-recorded and possibly live-recorded; and various mechanisms for injecting static images, video, or other multimedia into the in-line text streams (which become basic multimedia exchanges).

2. Description of Related Art

This patent draws upon gesture recognition technologies such as those embodied in the touch-interface of devices such as Apple iPad or Microsoft Kinect or various Android smartphones or LEAPmotion LEAP devices. It extends these gestures recognition technologies to novel applications in chat and instant message applications.

### BRIEF SUMMARY OF THE INVENTION

The novel techniques here describe an enhanced system that expands upon the current state of the art by using the full array of gesture-based input mechanisms available on the newest generation of mobile device to give instant messaging application users enhanced modes not only of inputting messages, but also of directing the actual content, form and style of the transmitted messages they send to their conversational partners, for example: with animated enhancements that are chosen and controlled through gestures.

### BRIEF DESCRIPTION OF THE SEVERAL VIEWS OF THE DRAWINGS

FIG. 1 basic illustration of a typical modern gesture-recognizing tablet-style device, from a message sender's perspective

FIG. 2 demonstration of using gestures on a sender's chat device to combine text and effects

FIG. 3 demonstration of using gesture on sender's chat device to set size or impact of applied effect

FIG. 4 demonstration of the receiver's chat device which receives the animated text plus effect (sent from the sender's device)

FIG. 5 Alternative embodiment of the sender's device when enabled to act as a “hands-in-air” special-gesture-recognizing device version of FIG. 2; no physical contact such as swiping is required; this is possible with a device which can recognize gestures made by the user in three dimensions

FIG. 6 demonstration of a message sender using a 3-d spatial gesture to choreograph an effect in a manner similar to that of FIG. 3, but this time without physical contact with the device; this is possible with a device which can recognize gestures made by the user in three dimensions

FIG. 7 Sender's chat device—example of using gestures to combine a “heart” effect with “I love you” text

FIG. 8 Continued illustration from FIG. 7 of fully combined “heart” with “I love you”

FIG. 9 Continued illustration of FIG. 8 of user dragging the combined text-and-heart effect to the edge of the chat application, whereby the chat application detects the gesture and “shrinks” in such a way that the user can then drag the combined text-and-heart effect into the “outer space” around the temporarily shrunken chat program interface; the “outer space” is an illusion the chat program creates in order to allow the user to choreograph the text-and-heart effect

FIG. 10 Continued illustration of FIG. 9 whereby the user can drag the heart-and-text effect in the “outer space” margin of the chat program in order to choreograph an entry from “stage right” for the receiver's benefit

FIG. 11 Continued illustration of FIG. 10 whereby the sender completes the choreography of the heart-and-text effect gesture

FIG. 12 The receiver's device can now receive the fully choreographed effect which the sender was able to create and choreograph using gestures

### DETAILED DESCRIPTION OF THE INVENTION

A variety of new computing devices, and sensory add-on devices to computers and tablets and video game consoles, now permit the primary computing device to interpret physical gestures by the user. These gestures include finger, hand and body movements the user makes by physical touching or swiping the device, and newer technologies even permit gesture recognition in the natural three-dimensional space around the device. Some examples of these gesture-recognizing technologies are the Apple iPhone and iPad and iPod, various Android smartphones, LeapMotion LEAP devices and Microsoft Kinect device. In addition, a computer with a camera or set of cameras or other specialized detection devices can analyze and calculate three-dimensional gestures by the user in real-time in such a fashion and with sufficient real-time or near-real-time speed to render the invention herein described practicable.

An application of these novel gesture sensing techniques is used to control, in new ways heretofore undescribed, instant message and chat software. Furthermore, a more advanced used of gestures can be made in the natural three-dimensional space around the device, which is possible with advanced devices enabled to recognize spatial gestures made in mid-air adjacent to the device, such as specifically is possible with full spatial sensing devices such as the LEAPmotion LEAP or Microsoft Kinect. Furthermore, adaptions of these novel techniques are used to allow users of less-advanced older-style phones, desktop and laptop computers similar abilities to direct similarly the content, form and style of their instant messages with users of compatible mobile applications on newer-style mobile devices, while being restricted to the traditional input interfaces (typically all or some of the following: keyboard, mouse and microphone) of their older-style devices.

This invention describes the use of gesture-enabled chat, extends the description to 3-dimentional gesture enabled chat, and describes how this could be used to create special chat effects such as animations and choreographed chat effects heretofore impracticable or inconvenient through conventional chat interfaces of keyboard and mouse.

1. Claimed is a method by which user can type, speak or gesturally-input text and then drag it with one finger and drag an effect with another finger, and touch effect with text to create a combined text-plus-effect action; certain effect may allow for enhanced “choreography” involving stretching, size, movement or direction which is indicated by gestural input (by touch, or in-air); complex effects will pop up a “go” button to hit once you are ready with the “choreography”

2. Claimed is a particular embodiment of gesture recognition, whereby method 1 may be done by touch gestures

3. Claimed is a particular embodiment whereby claim 1 can be enhanced by more-advanced non-touch (spatial 3-dimensional environmental gesture recognition). The claim 1 is thereby extended and generalized to the general concept of gesture-enabled chat with the newest-generation of devices which can sense hands and body position without touch using such mechanisms as infrared or visual-processing in 2 or more dimensions. The objects involved in the chat (text and effects) may be thus manipulated by gestures which do not involve the user physically touching the device. These gestures are any gesture interpretable by the device, such as the user's fingers, the users hands, the user's body, the user's face, or the user's facial expressions.

4. In a particular embodiment of claim 3, the user can use his or her face, or facial expressions, to control instant message effects, such as using a particular facial gesture. This could include eye and mouth movements to generate instant message effects such as emoticons or animations.

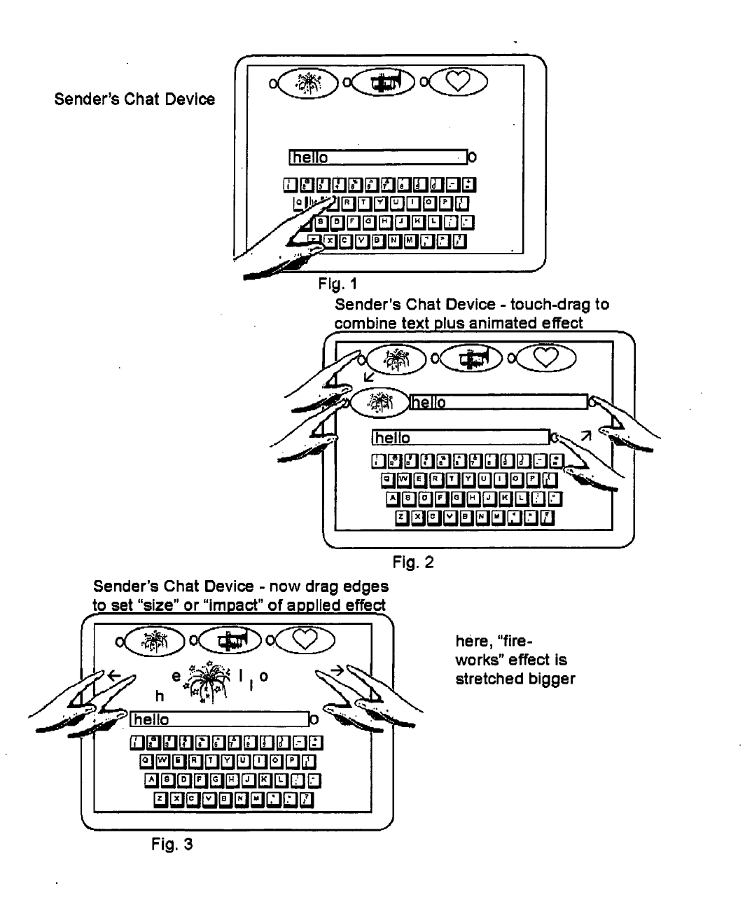

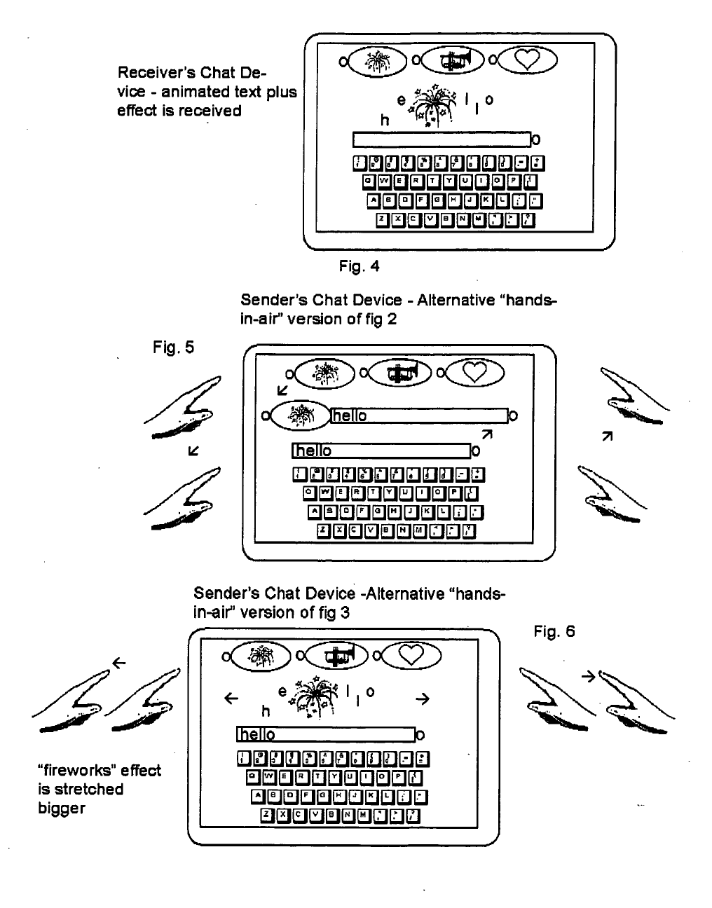

5. In a particular embodiment, claim 1 may be retrofitted or adapted to less-advanced devices using traditional keyboard and mouse. See FIGS. 1 for an example of basic text input; see FIG. 2 for an example of gesture-driven combination text with a pre-set effect; see FIG. 3 for an example of gesture-driven control of the “size” or “impact” of the effect to be applied, a form of effect choreography; see FIG. 4 for an example of the receiver's device receiving and displaying this transmitted combination of text plus effect; see FIG. 5 for an alternative claim of FIG. 2 whereby a hands-free version of text-plus-effect selection is made in the air nearby the sender's device, which the sender's device reads and interprets appropriately; see FIG. 6 for an alternative claim of FIG. 3 whereby a hands-free version of effect “size” or “impact” choreography is made in the air nearby the sender's device, which the sender's device reads and interprets appropriately.

6. Also claimed is an understanding whereby the “size” or “impact” of the instant messaging effect can also be understood to mean variations in animation path, timing, colors and other visual variables, and these variables can be controlled by a corresponding “size” or “impact” measurement of a user gesture through some dimensional measure such as gesture speed, gesture distance or direction from the sensing device, or via interpretation of the user's body parts such as fingers or hand or face or facial features in 3 dimensions.

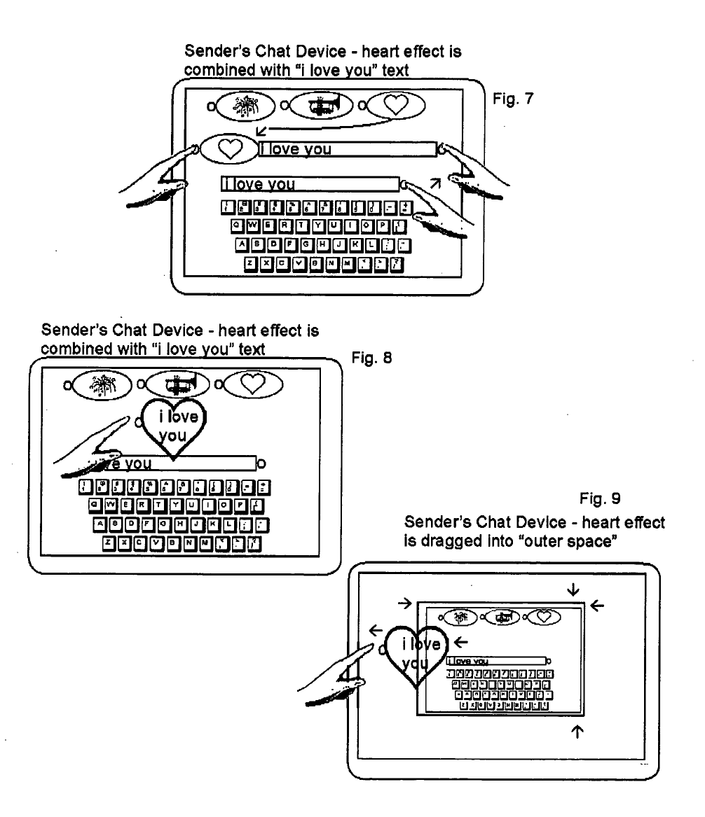

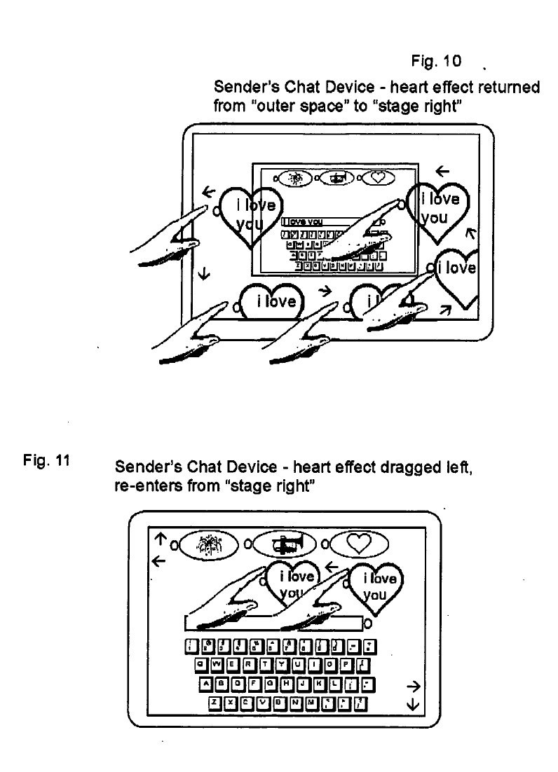

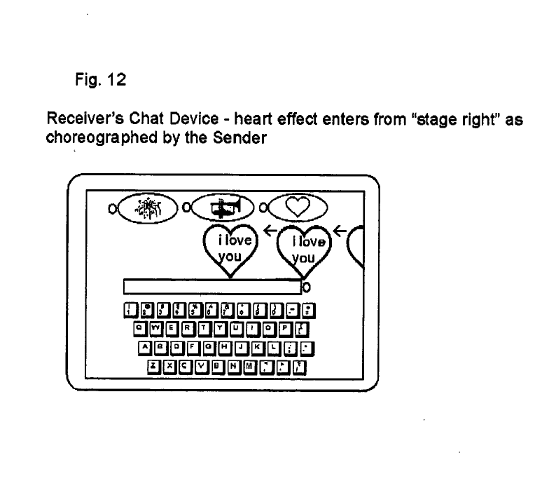

7. Also claimed is a special adaption of chat user interface on the sender's side whereby the choreography window may temporarily shrink when the user gestures to the edge of the choreography borders; when the choreography “stage” is thus touched (by physical touch or virtual gesture) the stage will temporarily shrink such that the user may gesture outside the stage area and drag or otherwise direct text or effects from the “outer space” around the stage; this permits the sender to choreograph text or effects from any arbitrary point around the perimeter of the stage. For example, a sender may combine a heart effect and “i love you” text as shown in FIG. 7, to produce a combined effect in FIG. 8, which is then dragged to the edge of the user interface boundary which then shrinks in response to reveal the “outer space” outside of the stage of choreography (FIG. 9); in FIG. 10, a sender may drag around a “heart” effect outside the stage, so he can choose the specific location from which the “heart” effect may re-enter, for example from the left or the right, when received by the receiver. Once the sender determines the final location in the “outer space” from which to re-enter the stage, he uses gestures to push his effect back onto the live stage, as shown in FIG. 11, and the stage will re-expand to normal size (also FIG. 11) so the sender can continue the choreography while viewing the text, effects and choreography stage in their normal proportions. An arrow or other indicator may appear to remind the sender of the current direction, path or nature of the choreography he has just orchestrated from the “outer space” area. Finally in FIG. 12, the receiver is depicted receiving the heart-effect with “i love you” text choreographed to enter from “stage right” of her user interface.

8. In a preferred embodiment of claim 6, all gestures may be carried out in three-dimensional space when it is more convenient to do so, such as when specifying the size or choreography of a gesture-enhanced effect, as long as the user's device is suitably equipped to recognize gestures in three-dimensional space.
